(19) United States
(12) Patent Application Publication
(10) Pub. No.: US 2020/0383000 A1
(43) Pub. Date: Dec. 3, 2020

(54) MME Load Balancer

(71) Applicant: Parallel Wireless, Inc., Nashua, NH (US)

(72) Inventors: Mahendra S. Rajput, Bangalore (IN); Kartik Shashikant Raval, Pune (IN)

(21) Appl. No.: 16/889,796

(22) Filed: Jun. 1, 2020

Related U.S. Application Data
(60) Provisional application No. 62/855,533, filed on May 31, 2019.

(51) Int. Cl. H04W 28/08; H04W 28/02; H04W 8/08; H04W 76/11

(52) U.S. Cl. CPC H04W 28/095; H04W 76/11; H04W 8/08; H04W 28/0226

(57) ABSTRACT

Systems, methods and computer software are disclosed for MME load balancing. In one embodiment, a method is disclosed, comprising: processing, at an MME, at least one of: an eNodeB Identifier (ID) in a setup request; Tracking Area Code (TAC) information in a setup request which an eNodeB is supporting against a configured TAC for nodes at the MME; and historical data relating to a maximum number of subscribers the MME has attached per peer. The method further includes determining a preferred load balancing arrangement at the MME based on the processing.

### CROSS-REFERENCE TO RELATED APPLICATIONS

This application claims priority under 35 U.S.C. § 119(e) to U.S. Provisional Pat. App. No. 62/855,533, filed May 31, 2019, titled “MME Load Balancer” which is hereby incorporated by reference in its entirety for all purposes. This application hereby incorporates by reference, for all purposes, each of the following U.S. Patent Application Publications in their entirety: US20170013513A1; US20170026845A1; US20170055186A1; US20170070436A1; US20170077979A1; US20170019375A1; US20170111482A1; US20170048710A1; US20170127409A1; US20170064621A1; US20170202006A1; US20170238278A1; US20170171828A1; US20170181119A1; US20170273134A1; US20170272330A1; US20170208560A1; US20170288813A1; US20170295510A1; US20170303163A1; and US20170257133A1. This application also hereby incorporates by reference U.S. Pat. No. 8,879,416, “Heterogeneous Mesh Network and Multi-RAT Node Used Therein,” filed May 8, 2013; U.S. Pat. No. 9,113,352, “Heterogeneous Self-Organizing Network for Access and Backhaul,” filed Sep. 12, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/034,915, “Dynamic Multi-Access Wireless Network Virtualization,” filed Sep. 24, 2013; U.S. patent application Ser. No. 14/289,821, “Method of Connecting Security Gateway to Mesh Network,” filed May 29, 2014; U.S. patent application Ser. No. 14/500,989, “Adjusting Transmit Power Across a Network,” filed Sep. 29, 2014; U.S. patent application Ser. No. 14/506,587, “Multicast and Broadcast Services Over a Mesh Network,” filed Oct. 3, 2014; U.S. patent application Ser. No. 14/510,074, “Parameter Optimization and Event Prediction Based on Cell Heuristics,” filed Oct. 8, 2014, U.S. patent application Ser. No. 14/642,544, “Federated X2 Gateway,” filed Mar. 9, 2015, and U.S. patent application Ser. No. 14/936,267, “Self-Calibrating and Self-Adjusting Network,” filed Nov. 9, 2015; U.S. patent application Ser. No. 15/607,425, “End-to-End Prioritization for Mobile Base Station,” filed May 26, 2017; U.S. patent application Ser. No. 15/803,737, “Traffic Shaping and End-to-End Prioritization,” filed Nov. 27, 2017, each in its entirety for all purposes, having attorney docket numbers PWS-71700US01, US02, US03, 71710US01, 71721US01, 71729US01, 71730US01, 71731US01, 71756US01, 71775US01, 71865US01, and 71866US01, respectively. This document also hereby incorporates by reference U.S. Pat. Nos. 9,107,092, 8,867,418, and 9,232,547 in their entirety. This document also hereby incorporates by reference U.S. patent application Ser. No. 14/822,839, U.S. patent application Ser. No. 15/828,427, U.S. Pat. App. Pub. Nos. US20170273134A1, US20170127409A1 in their entirety.

### BACKGROUND

A connection between ENodeB and a Mobility Management Entity (MME) uses a transport layer. Each ENodeB can establish only one association towards the MME. When a Home ENodeB Gateway (HeNBGW) is utilized, the HeNBGW which in itself aggregates thousands of small cells while appearing as single ENodeB to the core network, creates imbalance at MME in terms of association loads.

### SUMMARY

The present application discloses a method and system for an MME to know the current relative capacity of a connection coming in from HeNBGW or a macro ENodeB so that it can assign resources to handle the connection proportionately. In such a manner load balancing of the MME is achieved.

In one embodiment, a method is disclosed for load balancing connections at an MME. The method includes processing, at the MME, factors including at least one of an eNodeB Identifier (ID) in a setup request; Tracking Area Code (TAC) information in a setup request which an eNodeB is supporting against a configured TAC for nodes at the MME; and historical data relating to a maximum number of subscribers the MME has attached per peer. Based on the processing of at least one of these factors, a preferred load balancing arrangement is determined for the MME.

In another embodiment, a non-transitory computer-readable medium containing instructions for load balancing connections at an MME is disclosed. The instructions, when executed, cause an MME to perform steps including processing factors including at least one of an eNodeB Identifier (ID) in a setup request; Tracking Area Code (TAC) information in a setup request which an eNodeB is supporting against a configured TAC for nodes at the MME; and historical data relating to a maximum number of subscribers the MME has attached per peer. Based on the processing of at least one of these factors, a preferred load balancing arrangement is determined for the MME.

In another embodiment, an MME may be disclosed for providing load balancing connections at an MME. The MME processes factors to determine a load balancing arrangement, The factors include at least one of an eNodeB Identifier (ID) in a setup request; Tracking Area Code (TAC) information in a setup request which an eNodeB is supporting against a configured TAC for nodes at the MME; and historical data relating to a maximum number of subscribers the MME has attached per peer. Based on the processing of at least one of these factors, a preferred load balancing arrangement is determined for the MME.

### BRIEF DESCRIPTION OF THE DRAWINGS

FIG. 1 is a system diagram showing an MME interfacing with multiple UEs via eNodeBs and an HENBGW.

FIG. 2 is a system diagram showing an MME interfacing with multiple UEs via eNodeBs and an HENBGW, in accordance with some embodiments.

FIG. 3 is an enhanced eNodeB for performing the methods described herein, in accordance with some embodiments.

FIG. 4 is a coordinating server for providing services and performing methods as described herein, in accordance with some embodiments.

### DETAILED DESCRIPTION

Resources at MME (e.g., sub-systems) should be assigned to each ENB connection/association in proportion of the load (subscribers) provided by way of the connection. This can be dynamically adjusted as the load grows and shrinks.

While the following example refers to LTE and 4G Radio Access Technologies (RATs), it should be appreciated that any RAT could be used, at either the base station or the core network, including but not limited to 2G, 3G, Wi-Fi and 5G. Similarly, S1 interfaces and SCTP protocol are described in the example, however it should be appreciated that the invention should not be limited to S1 interfaces and SCTP protocol as other interfaces and protocols could be used. Similarly, base stations and core networks of 2G, 3G, 4G, and 5G may be mixed and interworking between protocols and virtualization of core networks and radio nodes may be used to enable inter-RAT embodiments. Similarly, 5G non-standalone as well as 5G standalone may be supported. These methods are well known to those having skill in the art.

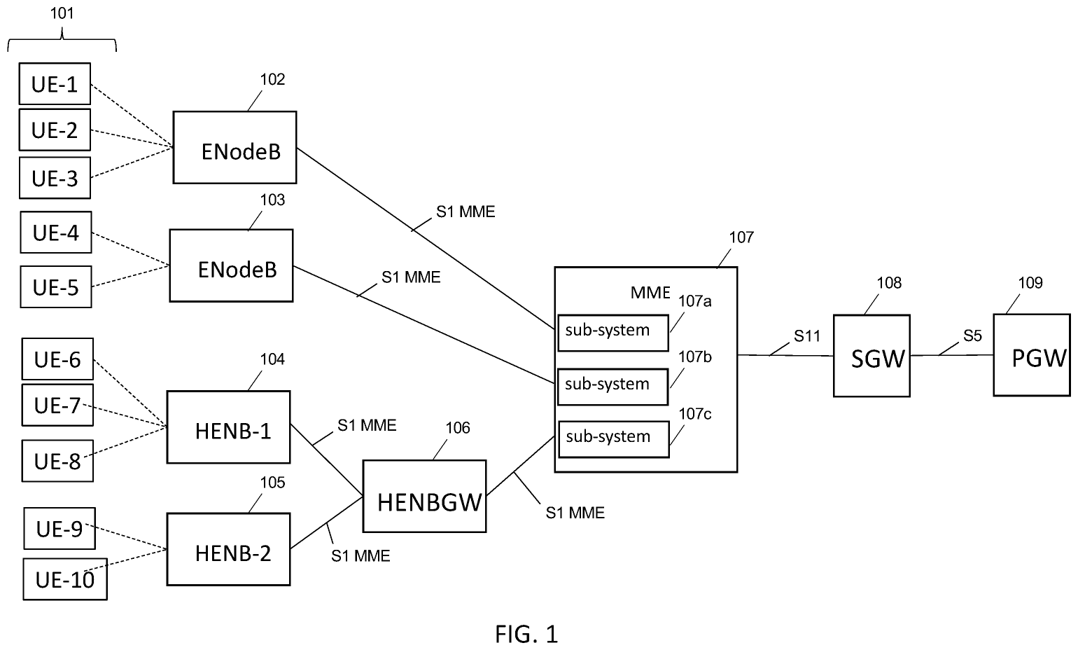

FIG. 1 shows a block diagram of a system without using load balancing for the MME. The MME 107 is interfacing with multiple UEs 101 via eNodeBs 102 and 103, and also Home eNodeBs 104 and 105. The HeNBGW (Home ENodeB gateway) 106 provides aggregation of S1 control plane traffic for Home eNodeBs 104 and 105. At the transport layer, the MME uses Stream Control Transmission Protocol (SCTP) associations to handle the S1-MME control plane traffic towards both eNodeB and HENBGWS. A multiple-MME server is shown, with subsystems 107a, 107b, 107c shown. The subsystems may be virtualized and may be running on one MME host or multiple MME hosts. The plurality of base stations direct their signaling toward a single destination MME, which may comprise multiple virtual instances of MMEs 107a, 107b, 107c. The destination MME may be a virtual MME provided at a coordination node or cloud coordination server or HetNet Gateway (HNG), which is a cloud coordination server that virtualizes the MMEs toward the base stations and also towards the core network (e.g., the SGW 108 and PGW 109), as defined elsewhere in the present disclosure and the documents incorporated by reference.

FIG. 1 shows where MME is interfacing with multiple UEs via eNodeBs. HeNBGW (Home ENodeB gateway) provides aggregation of S1 control plane traffic. At transport layer, MME uses SCTP associations to handle the S1-MME control plane traffic towards both eNodeB and HeNBGWs. UE-1, UE-2 and UE-3 are shown in communication with a first eNodeB. UE-4 and UE-5 are shown in communication with a second eNodeB. UE-6, UE-7 and UE-8 are shown in communication with HENB-1. UE-9 and UE-10 are shown in communication with HENB-2. HENB-1 and HENB-2 are in communication with HENBGW. Each of the first eNodeB, the second eNodeB and the HENBGW are in communication with an MME. The MME is in communication with a serving Gateway (SGW) which is in communication with a Packet Gateway (PGW).

In this example, the MME shows three sub-systems 107a, 107b, 107c, which could be any number and could be virtualized, identified from top to bottom. One sub-system for the first eNodeB, one sub-system for the second eNodeB and one sub-system for the HENBGW. The first sub-system is in communication with the first eNodeB by way of an S1-MME link carrying traffic of three UEs. The second sub-system is in communication with the second eNodeB by way of an S1-MME link carrying traffic of two UEs. The third sub-system is in communication with the HENBGW by way of an S1-MME link carrying traffic of five UEs. Therefore, the load at the MME is unbalanced, as the third sub-system is handling traffic for the same amount of UEs (5) as the first sub-system (3) and second sub-system (2) combined.

A S1 connection between ENodeB and MME uses SCTP as a transport layer. As per 3GPP specifications, each ENodeB can establish only one SCTP association towards MME. While this is appropriate for a macro ENodeB or for a small cell which directly connects to the MME, when we take the case of Home ENodeB Gateway (HeNBGW) which in itself aggregates thousands of small cells while appearing as single ENodeB to the core network, it creates imbalance at MME in terms of SCTP association loads. Resources at MME should be assigned to each ENB connection/association in proportion of the load(subscribers) it is bringing. Also, this will need to be dynamically adjusted as the load grows and shrinks. The solution given here proposes a way for MME to know the current relative capacity of a S1 connection coming in from HeNBGW or a macro ENodeB so that it can assign resources to handle the connection proportionately.

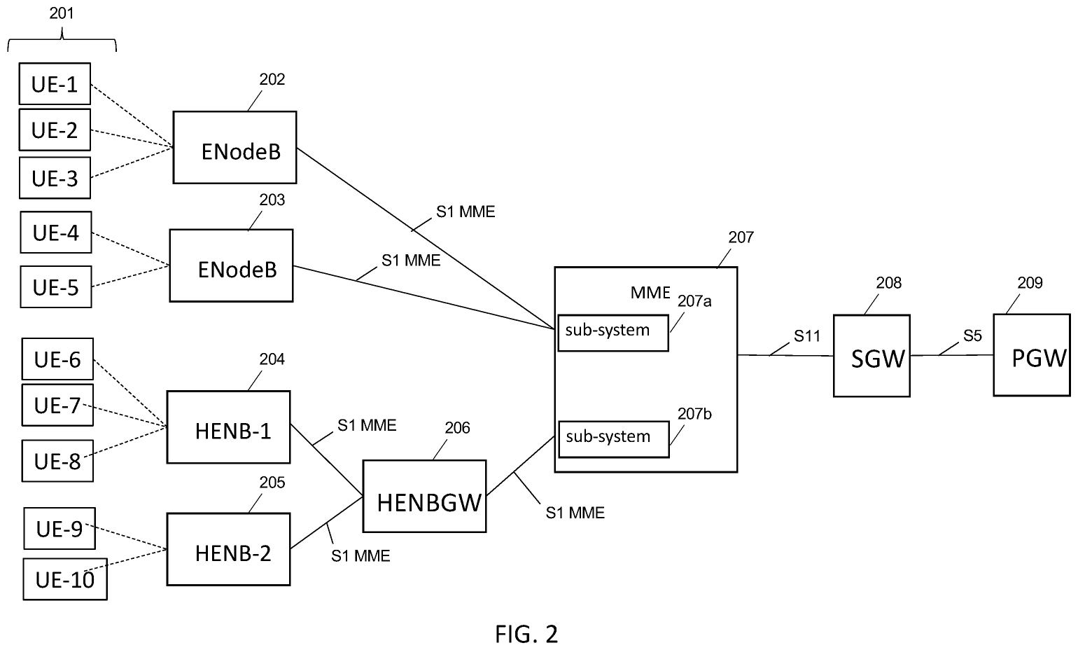

FIG. 2 shows a block diagram of a similar same system as shown in FIG. 1, except load balancing in accordance with one embodiment of the present invention has been provided for the MME. UE-1, UE-2 and UE-3 are shown in communication with a first eNodeB 202. UE-4 and UE-5 are shown in communication with a second eNodeB 203. UE-6, UE-7 and UE-8 are shown in communication with HENB-1 204. UE-9 and UE-10 are shown in communication with HENB-2 205. HENB-1 and HENB-2 are in communication with HENBGW 206. Each of the first eNodeB, the second eNodeB and the third eNodeB are in communication with an MME 207. The MME is in communication with a serving Gateway (SGW) 208 which is in communication with a Packet Gateway (PGW) 209.

The MME shows two sub-systems 207a and 207b, which may be virtual instances. The first sub-system is in communication with the first eNodeB by way of an S1-MME link carrying traffic of three UEs and also is in communication with the second eNodeB by way of an S1-MME link carrying traffic of two UEs. The second sub-system is in communication with the HENBGW by way of an S1-MME link carrying traffic of five UEs. In this embodiment, due to the load balancing process, the load between the first sub-system and the second subsystem is more equally shared, since each sub-system is handling the traffic of five UEs.

SCTP views individual association carrying same capacity and can't give preferential treatment for the association from HeNBGW unless we have some special mechanism to handle SCTP traffic for HeNBGW. At the same time HeNBGW support high number of home eNodeBs. MME shall allocate appropriate resources (e.g., CPU/memory) in its subsystem based on: Looking into the eNodeB ID in S1 Setup Request (eNodeB conventionally possesses 20 bit Id, while HenbGW possesses 28 bit Id). Looking into TAC information in S1 Setup request which eNodeB/HenbGW is supporting against the configured TAC for those nodes at MME. For instance, if TAC corresponds to HeNBGW high capacity resource shall be allocated else normal. Based on historical data of maximum number of subscribers MME has attached per S1-peer (eNodeB/HeNBGW), for example, MME shall gather max connection statistics to extrapolate the appropriate resource to be used. If a protocol other than SCTP is used, such as TCP, equivalent carrying protocols can be supported without difficulty.

In some embodiments, different virtual instances may be created, supporting different capacities. These capacities may be assigned using the resource allocation process described herein. In some embodiments, virtual instances may be created, destroyed, and/or reallocated when capacity is determined to be in a suboptimal allocation state. In some embodiments, TACs or identifiers of high capacity aggregation nodes may be stored or cached in a table, such as the TAC for HeNBGW 206; this may be useful in the event that multiple such gateways are connected to MME 207.

In some embodiments, MME 207 may host virtual instances of different RATs. In some embodiments, a gateway may host both a gateway, such as HeNBGW 206, and an MME function 207, as well as in some embodiments all or part of an SGW 208 and a PGW function 209. In some embodiments, virtual instances for different RATs may be provided for the functionality, enabling any combination of these functions to be hosted on a single host.

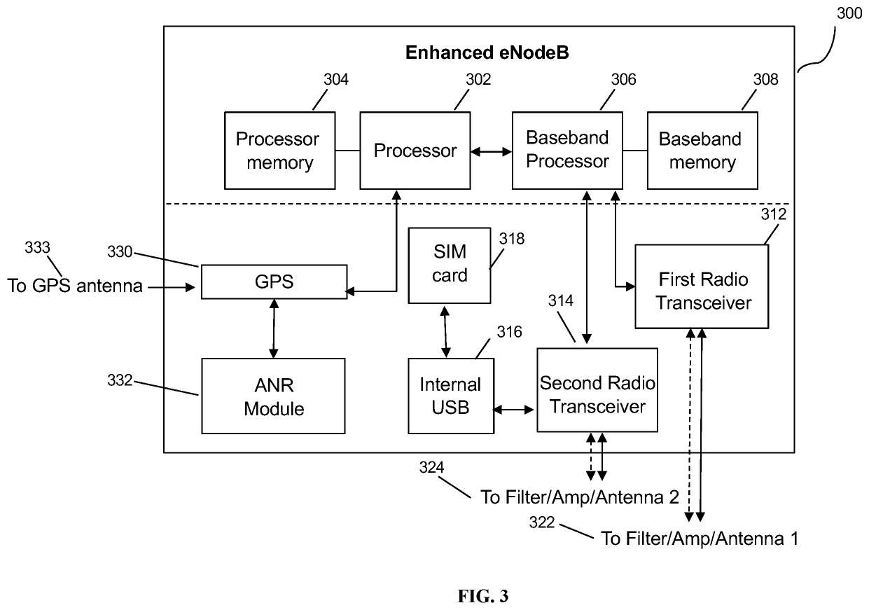

FIG. 3 is an enhanced eNodeB 300 for performing the methods described herein, in accordance with some embodiments. Enhanced eNodeB node 300 may include processor 302, processor memory 304 in communication with the processor, baseband processor 306, and baseband processor memory 308 in communication with the baseband processor. Enhanced eNodeB 300 may also include first radio transceiver 312 and second radio transceiver 314, internal universal serial bus (USB) port 316, and subscriber information module card (SIM card) 318 coupled to USB port 316. In some embodiments, the second radio transceiver 314 itself may be coupled to USB port 316, and communications from the baseband processor may be passed through USB port 316. The second radio transceiver may be used for wirelessly backhauling eNodeB 300.

Processor 302 and baseband processor 306 are in communication with one another. Processor 302 may perform routing functions, and may determine if/when a switch in network configuration is needed. Baseband processor 306 may generate and receive radio signals for both radio transceivers 312 and 314, based on instructions from processor 302. In some embodiments, processors 302 and 306 may be on the same physical logic board. In other embodiments, they may be on separate logic boards.

Processor 302 may identify the appropriate network configuration, and may perform routing of packets from one network interface to another accordingly. Processor 302 may use memory 304, in particular to store a routing table to be used for routing packets. Baseband processor 306 may perform operations to generate the radio frequency signals for transmission or retransmission by both transceivers 310 and 312. Baseband processor 306 may also perform operations to decode signals received by transceivers 312 and 314. Baseband processor 306 may use memory 308 to perform these tasks.

The first radio transceiver 312 may be a radio transceiver capable of providing LTE eNodeB functionality, and may be capable of higher power and multi-channel OFDMA. The second radio transceiver 314 may be a radio transceiver capable of providing LTE UE functionality. Both transceivers 312 and 314 may be capable of receiving and transmitting on one or more LTE bands. In some embodiments, either or both of transceivers 312 and 314 may be capable of providing both LTE eNodeB and LTE UE functionality. Transceiver 312 may be coupled to processor 302 via a Peripheral Component Interconnect-Express (PCI-E) bus, and/or via a daughtercard. As transceiver 314 is for providing LTE UE functionality, in effect emulating a user equipment, it may be connected via the same or different PCI-E bus, or by a USB bus, and may also be coupled to SIM card 318. First transceiver 312 may be coupled to first radio frequency (RF) chain (filter, amplifier, antenna) 322, and second transceiver 314 may be coupled to second RF chain (filter, amplifier, antenna) 324.

SIM card 318 may provide information required for authenticating the simulated UE to the evolved packet core (EPC). When no access to an operator EPC is available, a local EPC may be used, or another local EPC on the network may be used. This information may be stored within the SIM card, and may include one or more of an international mobile equipment identity (IMEI), international mobile subscriber identity (IMSI), or other parameter needed to identify a UE. Special parameters may also be stored in the SIM card or provided by the processor during processing to identify to a target eNodeB that device 300 is not an ordinary UE but instead is a special UE for providing backhaul to device 300.

Wired backhaul or wireless backhaul may be used. Wired backhaul may be an Ethernet-based backhaul (including Gigabit Ethernet), or a fiber-optic backhaul connection, or a cable-based backhaul connection, in some embodiments. Additionally, wireless backhaul may be provided in addition to wireless transceivers 312 and 314, which may be Wi-Fi 802.11a/b/g/n/ac/ad/ah, Bluetooth, ZigBee, microwave (including line-of-sight microwave), or another wireless backhaul connection. Any of the wired and wireless connections described herein may be used flexibly for either access (providing a network connection to UEs) or backhaul (providing a mesh link or providing a link to a gateway or core network), according to identified network conditions and needs, and may be under the control of processor 302 for reconfiguration.

A GPS module 330 may also be included, and may be in communication with a GPS antenna 333 for providing GPS coordinates, as described herein. When mounted in a vehicle, the GPS antenna may be located on the exterior of the vehicle pointing upward, for receiving signals from overhead without being blocked by the bulk of the vehicle or the skin of the vehicle. Automatic neighbor relations (ANR) module 332 may also be present and may run on processor 302 or on another processor, or may be located within another device, according to the methods and procedures described herein.

Other elements and/or modules may also be included, such as a home eNodeB, a local gateway (LGW), a self-organizing network (SON) module, or another module. Additional radio amplifiers, radio transceivers and/or wired network connections may also be included.

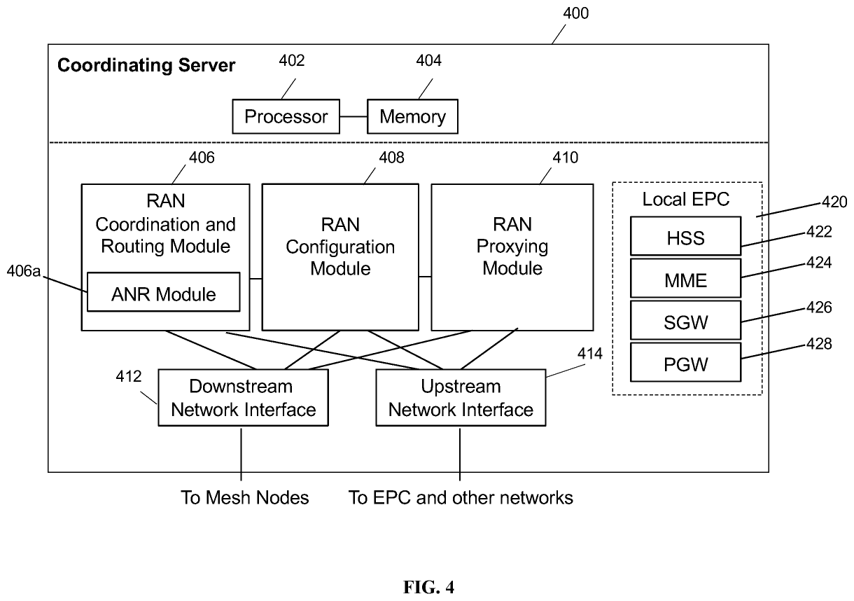

FIG. 4 is a coordinating server for providing services and performing methods as described herein, in accordance with some embodiments. Coordinating server 400 includes processor 402 and memory 404, which are configured to provide the functions described herein. Also present are radio access network coordination/routing (RAN Coordination and routing) module 406, including ANR module 406a, RAN configuration module 408, and RAN proxying module 410. The ANR module 406a may perform the ANR tracking, PCI disambiguation, ECGI requesting, and GPS coalescing and tracking as described herein, in coordination with RAN coordination module 406 (e.g., for requesting ECGIs, etc.). In some embodiments, coordinating server 400 may coordinate multiple RANs using coordination module 406. In some embodiments, coordination server may also provide proxying, routing virtualization and RAN virtualization, via modules 410 and 408. In some embodiments, a downstream network interface 412 is provided for interfacing with the RANs, which may be a radio interface (e.g., LTE), and an upstream network interface 414 is provided for interfacing with the core network, which may be either a radio interface (e.g., LTE) or a wired interface (e.g., Ethernet).

Coordinator 400 includes local evolved packet core (EPC) module 420, for authenticating users, storing and caching priority profile information, and performing other EPC-dependent functions when no backhaul link is available. Local EPC 420 may include local HSS 422, local MME 424, local SGW 426, and local PGW 428, as well as other modules. Local EPC 420 may incorporate these modules as software modules, processes, or containers. Local EPC 420 may alternatively incorporate these modules as a small number of monolithic software processes. Modules 406, 408, 410 and local EPC 420 may each run on processor 402 or on another processor, or may be located within another device.

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server, when other cells are in communication with the cloud coordination server. The eNodeB may communicate with the cloud coordination server to determine whether the UE has the ability to support a handover to Wi-Fi, e.g., in a heterogeneous network.

In some embodiments, the load balancer may be provided at a multi-MME server or MME virtualization server or cloud coordination server. In some embodiments, the load balancer may be provided as a separate software module, located on the same hardware as the cloud coordination server. In some embodiments, the load balancer may be a separate software process located at the cloud coordination server. In some embodiments, the MME subsystems may communicate with the load balancer and/or with each other to perform load balancing as described herein.

In some embodiments, various measures of load may be used to determine how and when to balance MMEs. In some embodiments, other SCTP flows may be balanced in addition to MME traffic. In some embodiments, the traffic may be balanced in conjunction with other traffic heading into the virtualized MME, including with 2G/3G/4G/5G/Wi-Fi control plane traffic. For example, load from other RAT control plane traffic on a link or node to be optimized may be considered when performing load balancing. In some embodiments, other IP traffic or memory load or process limits or backhaul limits or CPU load or other load factors may be considered when performing load balancing.

In one embodiment, a method is disclosed for load balancing connections at an MME. The method includes processing, at the MME, factors including at least one of an eNodeB Identifier (ID) in a setup request; Tracking Area Code (TAC) information in a setup request which an eNodeB is supporting against a configured TAC for nodes at the MME; and historical data relating to a maximum number of subscribers the MME has attached per peer. Based on the processing of at least one of these factors, a preferred load balancing arrangement is determined for the MME.

It is understood that the eNB ID and TAC, for example, are specific to certain 4G technologies but that equivalents exist for 2G/3G/4G/5G/Wi-Fi and the present disclosure is intended to apply to such equivalents. For example, ECGI may be used. Multiple RAT equivalents may be load balanced together with each other. ENB ID, TAC, and other identifiers may be stored at the load balancer and/or the coordinating node and may be associated with UEs at the load balancer and/or the coordinating node, and may be used for load balancing thereat.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to the Long Term Evolution (LTE) standard, one of skill in the art would understand that these systems and methods could be adapted for use with other wireless standards or versions thereof.

In some embodiments, the software needed for implementing the methods and procedures described herein may be implemented in a high level procedural or an object-oriented language such as C, C++, C#, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, other 3G/2G, legacy TDD, or other air interfaces used for mobile telephony.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment. Other embodiments are within the following claims.

1. A method for load balancing connections at a Mobility Management Entity (MME), comprising:
processing, at an MME, at least one of:
an eNodeB Identifier (ID) in a setup request;
Tracking Area Code (TAC) information in a setup request which an eNodeB is supporting against a configured TAC for nodes at the MME; and
historical data relating to a maximum number of subscribers the MME has attached per peer; and
determining, by a load balancer associated with the MME, a preferred load balancing arrangement at the MME based on the processing.

2. The method of claim 1 wherein processing an eNodeB identifier includes looking into an eNodeB ID in an S1 Setup Request.

3. The method of claim 1 wherein processing the TAC information includes allocating a high capacity resource if the TAC corresponds to a HeNBGW.

4. The method of claim 1 wherein determining a preferred load balancing arrangement at the MME includes gathering maximum connection statistics and extrapolating from the maximum connection statistics a resource to be used.

5. The method of claim 1 further comprising at least one of: providing the load balancer at a multi-MME server, MME virtualization server, or cloud coordination server; and providing the load balancer as a separate software module located on the same hardware as the cloud coordination server or as a separate software process located at the cloud coordination server.

6. The method of claim 1 wherein determining a preferred load balancing arrangement includes at least one of: using various measures of load to determine how and when to balance MMEs; balancing other SCTP flows in addition to MME traffic; balancing the traffic in conjunction with other traffic heading into the virtualized MME, including with 2G/3G/4G/5G/Wi-Fi control plane traffic; and using other IP traffic or memory load or process limits or backhaul limits or CPU load.

7. A non-transitory computer-readable medium containing instructions for providing load balancing connections at a Mobility Management Entity (MME) which, when executed, cause an MME to perform steps comprising:
processing at least one of:
an eNodeB Identifier (ID) in a setup request;
Tracking Area Code (TAC) information in a setup request which an eNodeB is supporting against a configured TAC for nodes at the MME; and
historical data relating to a maximum number of subscribers the MME has attached per peer; and
determining, by a load balancer associated with the MME, a preferred load balancing arrangement at the MME based on the processing.

8. The computer-readable medium of claim 7 further containing instructions wherein processing an eNodeB identifier includes looking into an eNodeB ID in an S1 Setup Request.

9. The computer-readable medium of claim 7 further containing instructions wherein processing the TAC information includes allocating a high capacity resource if the TAC corresponds to a HeNBGW.

10. The computer-readable medium of claim 7 further containing instructions wherein determining a preferred load balancing arrangement at the MME includes gathering maximum connection statistics and extrapolating from the maximum connection statistics a resource to be used.

11. The computer-readable medium of claim 7 further containing instructions comprising at least one of: providing the load balancer at a multi-MME server, MME virtualization server, or cloud coordination server; and providing the load balancer as a separate software module located on the same hardware as the cloud coordination server or as a separate software process located at the cloud coordination server.

12. The computer-readable medium of claim 7 further containing instructions wherein determining a preferred load balancing arrangement includes at least one of: using various measures of load to determine how and when to balance MMEs; balancing other SCTP flows in addition to MME traffic; balancing the traffic in conjunction with other traffic heading into the virtualized MME, including with 2G/3G/4G/5G/Wi-Fi control plane traffic; and using other IP traffic or memory load or process limits or backhaul limits or CPU load.

13. A system for load balancing connections at a Mobility Management Entity (MME), comprising:
an MME;
a plurality of User Equipments (UEs), in communication with the MME; and
wherein the MME processes at an MME, at least one of:
an eNodeB Identifier (ID) in a setup request;
Tracking Area Code (TAC) information in a setup request which an eNodeB is supporting against a configured TAC for nodes at the MME; and
historical data relating to a maximum number of subscribers the MME has attached per peer; and
wherein a load balancer associated with the MME determines a preferred load balancing arrangement at the MME based on the processing.

14. The system of claim 13 wherein the MME processes an eNodeB identifier by looking into an eNodeB ID in an S1 Setup Request.

15. The system of claim 13 wherein the MME processes the TAC information by allocating a high capacity resource if the TAC corresponds to a HeNBGW.

16. The system of claim 13 wherein determining the MME determines a preferred load balancing arrangement by gathering maximum connection statistics and extrapolating from the maximum connection statistics a resource to be used.

17. The system of claim 13 further wherein the load balancer is provided by at least one of: the load balancer is provided at a multi-MME server, MME virtualization server, or cloud coordination server; and the load balancer is provided as a separate software module located on the same hardware as the cloud coordination server or as a separate software process located at the cloud coordination server.

18. The system of claim 13 wherein a preferred load balancing arrangement includes at least one of: using various measures of load to determine how and when to balance MMEs; balancing other SCTP flows in addition to MME traffic; balancing the traffic in conjunction with other traffic heading into the virtualized MME, including with 2G/3G/4G/5G/Wi-Fi control plane traffic; and using other IP traffic or memory load or process limits or backhaul limits or CPU load.
